(19) United States
(12) Patent Application Publication
(10) Pub. No.: US 2023/0236804 A1
(43) Pub. Date: Jul. 27, 2023

(54) Method and Apparatus for Automatic Programming

(71) Applicant: Siemens Ltd., China, Beijing (CN)

(72) Inventors: Xin Jin, Beijing (CH); Liang Liao, Beijing (CN)

(73) Assignee: Siemens Ltd., China, Beijing (CN)

(21) Appl. No.: 18/003,704

(22) PCT Filed: Jun. 30, 2020
(86) PCT No.: PCT/CN2020/099352

§ 371 Date: Dec. 29, 2022

(51) Int. Cl. G06F 8/34; G06F 3/0486; G06F 3/0482; G06F 9/451

(52) U.S. Cl. CPC G06F 8/34; G06F 3/0486; G06F 3/0482; G06F 9/451

(57) ABSTRACT

Various embodiments include a method for automatic programming. The method may include: receiving a user's request to create a first global parameter of a specific type by detecting the user's dragging a control corresponding to the specific type from a first user interface and dropping the control on a second user interface; displaying a first popup window for editing the first global parameter on the second user interface; receiving the user's editing operations on the first global parameter in the first popup window; creating the first global parameter according to the user's editing operations; and displaying a new added first card of the first global parameter in a list of global parameters on a third user interface.

### CROSS-REFERENCE TO RELATED APPLICATIONS

This application is a U.S. National Stage Application of International Application No. PCT/CN2020/099352 filed Jun. 30, 2020, which designates the United States of America, the contents of which are hereby incorporated by reference in their entirety.

### TECHNICAL FIELD

The present disclosure relates to techniques of automatic programming. Various embodiments of the teachings herein include methods, apparatus, and computer-readable storage media for automatic programming.

### BACKGROUND

In the process of programming with robots, automatic production lines and other automatic programming tools, there are often values which need to be reused. At present, programmers usually use variables to record these values and reference them via variable names. In the following program, variable “tensor” is used to record reused values:
import torch
from torch.autograd import Variable
tensor=torch.Tensor([[1,2],{3,4]])
variable=Variable (tensor, requires_grad=True)
tensor
   tensor([[1., 2.],
   [3.,4.]])
   variable
   tensor([[1., 2.],
   [3.,4.]], requires_grad=True)

Using variables to record values that are used repeatedly has some disadvantages, such as not being intuitive, difficult to remember, and so on. Therefore, programmers need an intuitive tool, which can record, import and modify these reused values easily and quickly even without programming experience.

### SUMMARY

Various embodiments of the present disclosure include methods and apparatuses for automatic programming. For example, some embodiment include a method (100) for automatic programming, comprising: receiving (S101) a user's request on creating a first global parameter of a specific type by detecting the user's dragging a control corresponding to the specific type from a first user interface (701) and dropping the control on a second user interface (702); displaying (S102) a first popup window (804) for editing the first global parameter on the second user interface (702); receiving (S103) the user's editing operations on the first global parameter in the first popup window (804); creating (S104) the first global parameter according to the user's editing operations on the first global parameter; and displaying (S105) a new added first card (802) of the first global parameter in a list (802′) of global parameters on a third user interface (703).

In some embodiments, the method further comprises: receiving (S106) the user's request of setting relation of a second global parameter with a first FB displayed on the second user interface (702) by detecting the user's dragging of a second card (802) of the second global parameter from the third user interface (703) and dropping on the second user interface (702) if predefined condition is met; displaying (S107) a second popup window (804) for editing the second global parameter on the second user interface (702); receiving (S108) the user's editing operations on the second global parameter in the second popup window (804); and setting (S109) the first FB according to the user's operations on the second global parameter.

In some embodiments, the user's editing operations include changing the second global parameter into a local parameter, and setting (S109) the first FB according to the user's operations on the second global parameter comprises: creating a first local parameter and inheriting values of data items of the second global parameter to the first local parameter.

In some embodiments, the user's editing operations include changing a second local parameter into a third global parameter, and the method further comprises: creating (S110) the third global parameter and inheriting values of data items of the second local parameter to the third global parameter; and displaying (S111) a new added third card (802) of the third global parameter in the list (802′) of global parameters on a third user interface (703).

In some embodiments, the method further comprises: detecting (S112) the user's selecting a fourth card (803) of a fourth global parameter; and displaying (S113) at least one FB using the fourth global parameter in a highlighted way on the second user interface (702).

In some embodiments, the method further comprises: receiving (S114) the user's modification request on a fifth global parameter by detecting the user's clicking on a first button on a card (802) of the fifth global parameter; displaying (S115) a third popup window (804) for editing the fifth global parameter on the second user interface (702); receiving (S116) the user's editing operations on the fifth global parameter in the third popup window (804); updating (S117) all FBs referring to the fifth global parameter when detecting the user's clicking on a second button in the third popup window (804); and closing (S118) the third popup window (804) and displaying (S119) the updating status of all FBs referring to the fifth global parameter.

In some embodiments, types of a global parameter comprise at least one of the following items: motion path, wherein a global parameter of the type motion path includes at least one position group, each position group corresponds to a point on a motion path, data items of each position group include position coordinates, speed and acceleration; position coordinate; I/O channel; and value.

As another example, some embodiments include an apparatus (10) for automatic programming, comprising: a user interaction module (201), configured to receive a user's request on creating a first global parameter of a specific type by detecting the user's dragging a control corresponding to the specific type from a first user interface (701) and dropping the control on a second user interface (702); a displaying module (202), configured to display a first popup window (804) for editing the first global parameter on the second user interface (702); a processing module (203), configured to receive the user's editing operations on the first global parameter in the first popup window (804); and create the first global parameter according to the user's editing operations on the first global parameter; and the displaying module (202), further configured to display a new added first card (802) of the first global parameter in a list (802′) of global parameters on a third user interface (703).

In some embodiments, the user interaction module (201), further configured to receive the user's request of setting relation of a second global parameter with a first FB displayed on the second user interface (702) by detecting the user's dragging of a second card (802) of the second global parameter from the third user interface (703) and dropping on the second user interface (702) if predefined condition is met; the displaying module (202), further configured to display a second popup window (804) for editing the second global parameter on the second user interface (702); the user interaction module (201), further configured to receive the user's editing operations on the second global parameter in the second popup window (804); and the processing module (203), further configured to set the first FB according to the user's operations on the second global parameter.

In some embodiments, the user's editing operations include changing the second global parameter into a local parameter, and the processing module (203) is further configured to create a first local parameter and inheriting values of data items of the second global parameter to the first local parameter, when setting the first FB according to the user's operations on the second global parameter.

In some embodiments, the user's editing operations include changing a second local parameter into a third global parameter, and the processing module (203) is further configured to create the third global parameter and inherit values of data items of the second local parameter to the third global parameter; and the displaying module (202) is further configured to display a new added third card (802) of the third global parameter in the list (802′) of global parameters on a third user interface (703).

In some embodiments, the user interaction module (201), further configured to detect the user's selecting a fourth card (803) of a fourth global parameter; the displaying module (202), further configured to display at least one FB using the fourth global parameter in a highlighted way on the second user interface (702).

In some embodiments, the user interaction module (201), further configured to receive the user's modification request on a fifth global parameter by detecting the user's clicking on a first button on a card (802) of the fifth global parameter; the displaying module (202), further configured to display a third popup window (804) for editing the fifth global parameter on the second user interface (702); the user interaction module (202), further configured to receive the user's editing operations on the fifth global parameter in the third popup window (804); the processing module (203), further configured to update all FBs referring to the fifth global parameter when detecting the user's clicking on a second button in the third popup window (804); and the user interaction module (201), further configured to close the third popup window (804) and display the updating status of all FBs referring to the fifth global parameter.

In some embodiments, types of a global parameter comprise at least one of the following items: motion path, wherein a global parameter of the type motion path includes at least one position group, each position group corresponds to a point on a motion path, data items of each position group include position coordinates, speed and acceleration; position coordinate; I/O channel; and value.

As another example, some embodiments include an apparatus (10) for automatic programming, comprising: at least one processor (102); and at least one memory (101), coupled to the at least one processor (102), configured to execute one or more of the methods as described herein.

As another example, some embodiments include a computer-readable medium for automatic programming, storing computer-executable instructions, wherein the computer-executable instructions when executed cause at least one processor to execute one or more of the methods described herein.

### BRIEF DESCRIPTION OF THE DRAWINGS

The above mentioned attributes and other features and advantages of the present technique and the manner of attaining them will become more apparent and the present technique itself will be better understood by reference to the following description of embodiments of the present technique taken in conjunction with the accompanying drawings, wherein:

FIG. 1 depicts a block diagram of an apparatus for automatic programming incorporating teachings of the present disclosure;

FIG. 2 depicts flow diagrams of a method for automatic programming incorporating teachings of the present disclosure;

FIG. 3 depicts user interfaces used during automatic programming;

FIG. 4 depicts different types of global parameters;

FIG. 5A depicts procedure of creating a new global parameter of type “Motion path”;

FIG. 5B depicts procedure of creating a new global parameter of type “Position coordinate”;

FIG. 5C depicts procedure of creating a new global parameter of type “value”;

FIG. 6A and FIG. 6B depict procedure of editing a global parameter;

FIG. 6C depicts changing a global parameter to a local parameter and changing another local parameter to a global parameter;

FIG. 7 depicts highlighting of function blocks using a global parameter; and

FIG. 8A and FIG. 8B depict procedure of modifying a global parameter and expanding the modification to function blocks.

### REFERENCE NUMBERS

10, an apparatus for automatic programming
101, at least one memory
102, at least one processor
103, an input interface
104, an output interface
105, a communication module
20, an automatic programming program
201, a user interaction module
202, a displaying module
203, a processing module
301, 302, input devices
40, an output device
50, a robot
60, global parameters used in the automatic programming program 20
100, a method for automatic programming
S101-S119, steps of method 100
701, a first user interface
702, a second user interface
703, a third user interface
801, Function library
802, a card of a global parameter
802′, a list of cards of global parameters
803, control of a global parameter in the function library 801
804, a popup window for editing a global parameter
805, button for changing a local parameter into a global parameter

### DETAILED DESCRIPTION

With the dragging-dropping-editing-listing steps, a global parameter of a desired type can be easily added and the adding result is also shown user-friendly and intuitively. Also, With the dragging-dropping-editing-listing steps, a global parameter can be easily referenced by one or multiple FBs. Use and editing of a global parameter in a FB can be much more easily and conveniently. What's more, FBs referring to a specific global parameter can be easily viewed. And, with the easy operations “Expand All” and “Save to all”, a global parameter's modification can be easily expanded to each FB, saving programming time and results of synchronization be viewed intuitively.

Hereinafter, above-mentioned and other features of the present technique are described in detail. Various embodiments are described with reference to the drawings, where like reference numerals are used to refer to like elements throughout. In the following description, for purpose of explanation, numerous specific details are set forth in order to provide a thorough understanding of one or more embodiments. It may be noted that the illustrated embodiments are intended to explain, and not to limit the scope of the disclosure. It may be evident that such embodiments may be practiced without these specific details.

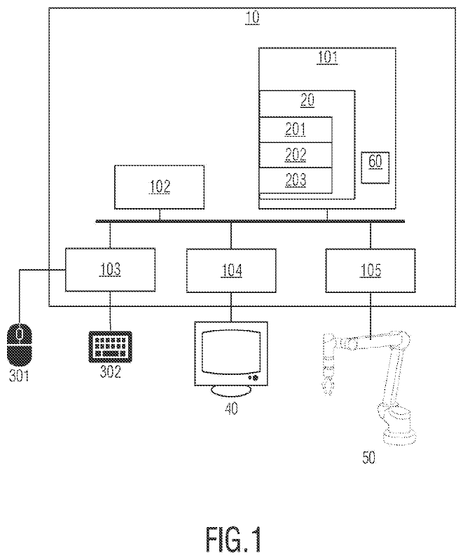

When introducing elements of various embodiments of the present disclosure, the articles “a”, “an”, “the” and “said” are intended to mean that there are one or more of the elements. The terms “comprising”, “including” and “having” are intended to be inclusive and mean that there may be additional elements other than the listed elements. Now the present disclosure will be described hereinafter in details by referring to FIG. 1 to FIG. 8B.

FIG. 1 depicts a block diagram of an apparatus incorporating teachings of the present disclosure. The apparatus 10 for automatic programming presented can be implemented as a network of computer processors, to execute following method 100 for automatic programming presented in the present disclosure. The apparatus 10 can also be a single computer, as shown in FIG. 1, including at least one memory 101, which includes computer-readable medium, such as a random access memory (RAM). The apparatus 10 also includes at least one processor 102, coupled with the at least one memory 101.

Computer-executable instructions are stored in the at least one memory 101, and when executed by the at least one processor 102, can cause the at least one processor 102 to perform the steps described herein. The at least one processor 102 may include a microprocessor, an application specific integrated circuit (ASIC), a digital signal processor (DSP), a central processing unit (CPU), a graphics processing unit (GPU), state machines, etc. embodiments of computer-readable medium include, but not limited to a floppy disk, CD-ROM, magnetic disk, memory chip, ROM, RAM, an ASIC, a configured processor, all optical media, all magnetic tape or other magnetic media, or any other medium from which a computer processor can read instructions. Also, various other forms of computer-readable medium may transmit or carry instructions to a computer, including a router, private or public network, or other transmission device or channel, both wired and wireless. The instructions may include code from any computer-programming language, including, for example, C, C++, C#, Visual Basic, Java, and JavaScript.

The at least one memory 101 shown in FIG. 1 can contain an automatic programming program 20, when executed by the at least one processor 102, causing the at least one processor 102 to execute the method 100. Global parameters 60 used during programming can also be stored in the at least one memory 101. The global parameters 60 can be sent via a communication module 105 to a robot 50 or other devices for controlling these devices. Users' setting of a global parameter 60 via an input device, such as a mouse 301 and/or a keyboard 302, can be received via an input interface 103. And programming user interfaces, such as a first user interface 701, a second user interface 702 and a third user interface 703 can be displayed via an output interface 104 on an output device 40.

The automatic programming program 20 can include:
a user interaction module 201, configured to interact with a user, such as receiving the user's operation request during programming;
a displaying module 202, configured to display user interfaces;
a processing module 203, configured to process parameters, including global parameters and optionally local parameters, and optionally to process function blocks and other items during programming.

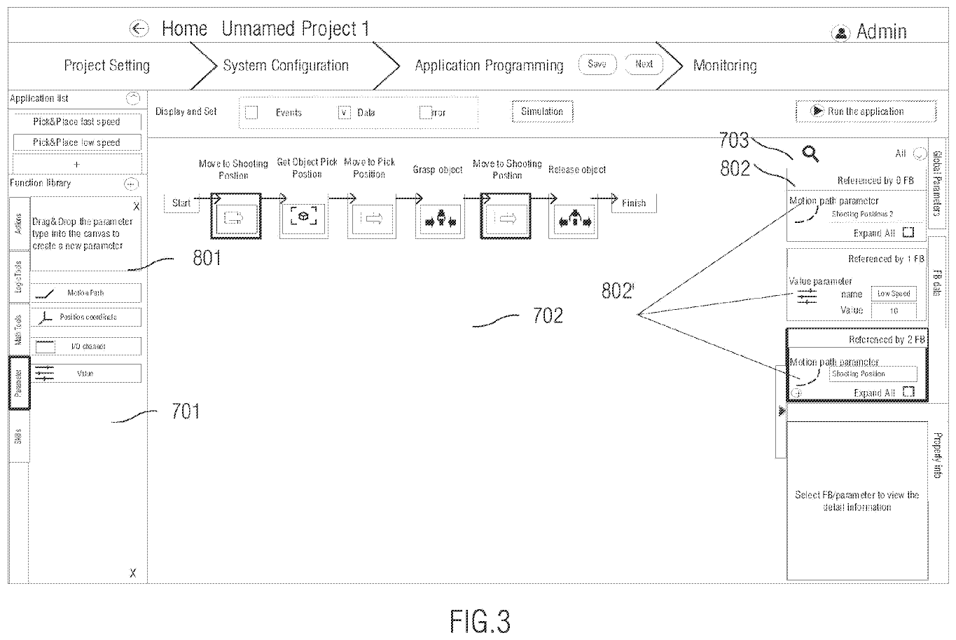

As shown in FIG. 3, there can be three main user interfaces during programming, they are: a first user interface 701, a second user interface 702 and a third user interface 703.

A Function library 801 can be displayed on the first user interface 701. There can be multiple groups of functions in the

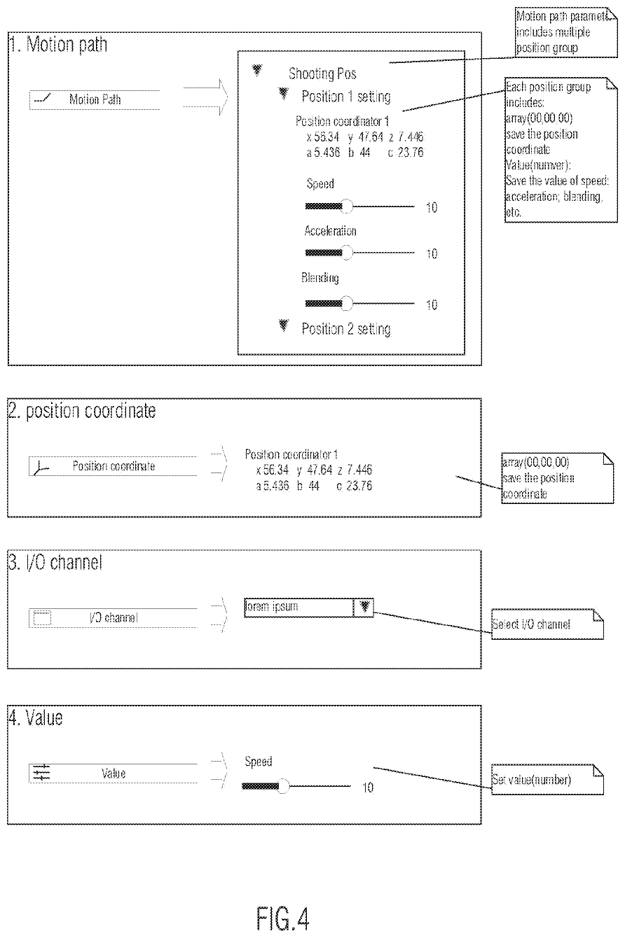

Function library 801, such as “Action”, “Logic Tools”, “Math Tools”, “Parameter” and “Skills”. when the control “parameter” is selected, types of global parameters will be displayed on the first user interface 701. Types of global parameters include but not limited to: “Motion path”, “Position coordinate”, “I/O channel” and “Value” (details of the types are shown in FIG. 4). There are can be controls in the Function library 801 for global parameters, corresponding respectively to the above four types. When any of the four controls is dragged to a second user interface 702, a global parameter of the corresponding type can be created and edited on the second user interface 702. When the editing is done and the global parameter is saved, a new card 802 of the global parameter will be displayed in a list 802′ on the third user interface 703.

With such a design, users can easily and clearly get to know what types of global parameters can be used and what global parameters have already been added. With the separate area of editing data items of a global parameter, users can focus on details of global parameter. Such separate user interfaces design can also make adding, editing and viewing use of global parameters become more easily.

Now referring to FIG. 4, details of types of global parameters are shown. The type “Motion path” is configured for robot motion path planning. The type “Position coordinate” is configured for reuse of coordinate position. The type “I/O channel” is configured for importing an I/O channel. The type “Value” is configured for reuse of speed or other simple values.

As shown in FIG. 4, a global parameter of the type “Motion path” can include at least one position group, each position group corresponds to a point on the motion path. Data items of a position group can include but not limited to:
Position coordinator, such as “Position coordinator 1”, which means position coordinates of “position 1” on the motion path;
Speed, which means moving speed of the robot when passing the “position 1”;
Acceleration, which means acceleration of the movement of the robot when passing the “position 1”;
Blending, which indicates the motion path's smoothness.

As shown in FIG. 4, a global parameter of the type “position coordinate” indicates a point's Cartesian coordinates during robotic programming. As shown in FIG. 4, a global parameter of the type “I/O channel” indicates type of an I/O channel used during robotic programming. User can select I/O channel type according to actual application scenario.

As shown in FIG. 4, a global parameter of the type “value” indicates value of a physical quantity, such as speed, acceleration, etc. Predefining types of global parameters helps operations related to global parameters. Predefinitions on types for a specific application will make programming much more convenient.

In some embodiments, the following operations can be made on a global parameter:

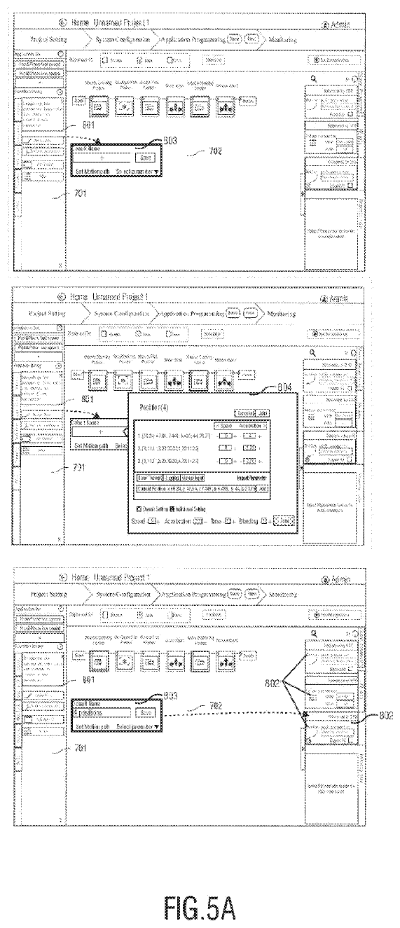

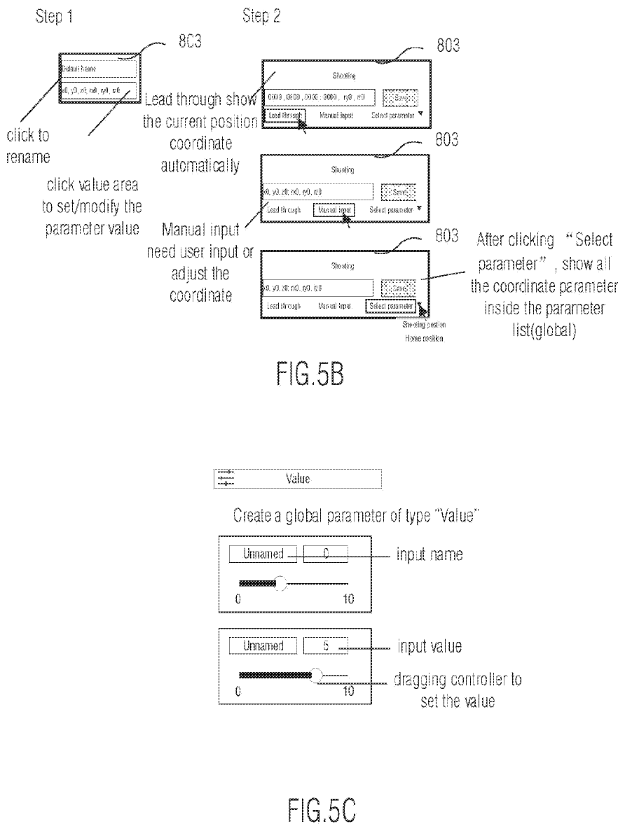

1) creating a global parameter (shown in FIG. 5A, FIG. 5B and FIG. 5C);

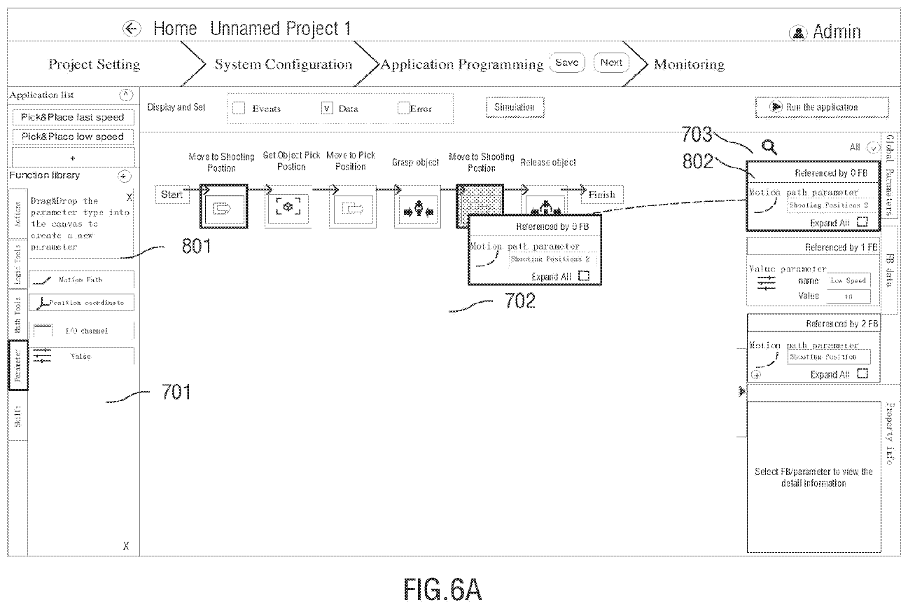

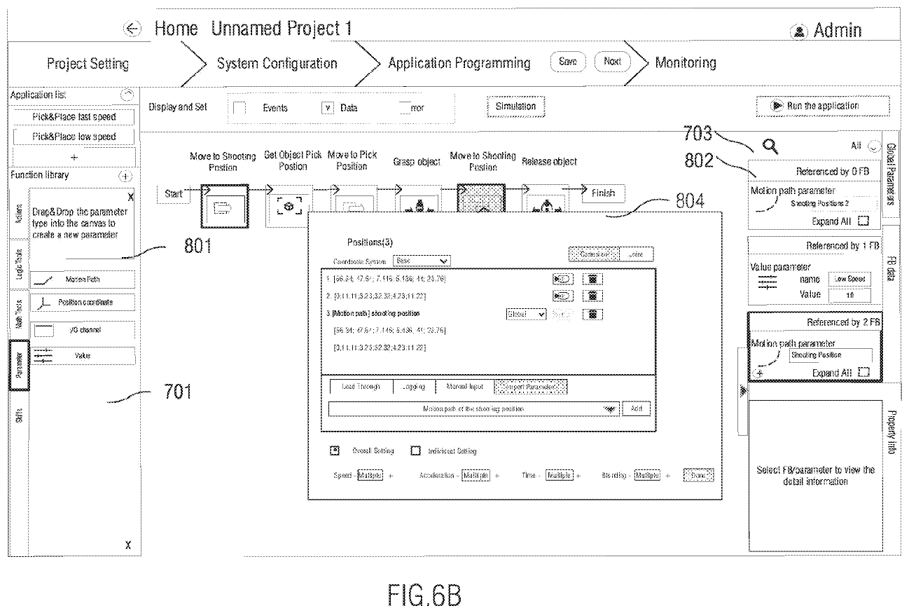

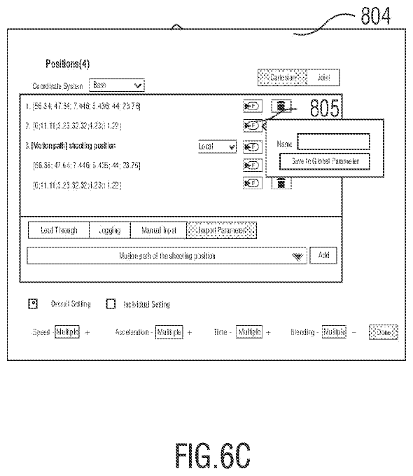

2) editing a global parameter in an FB (function block) (shown in FIG. 6A, FIG. 6B and FIG. 6C) (FB is used in automatic programming which implement a specific function. FB can be reused);

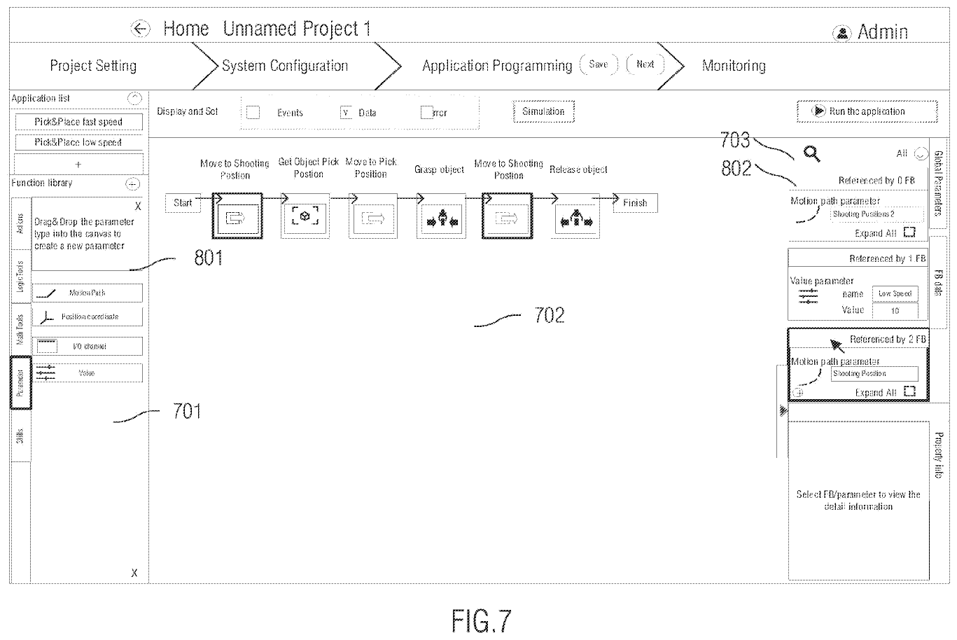

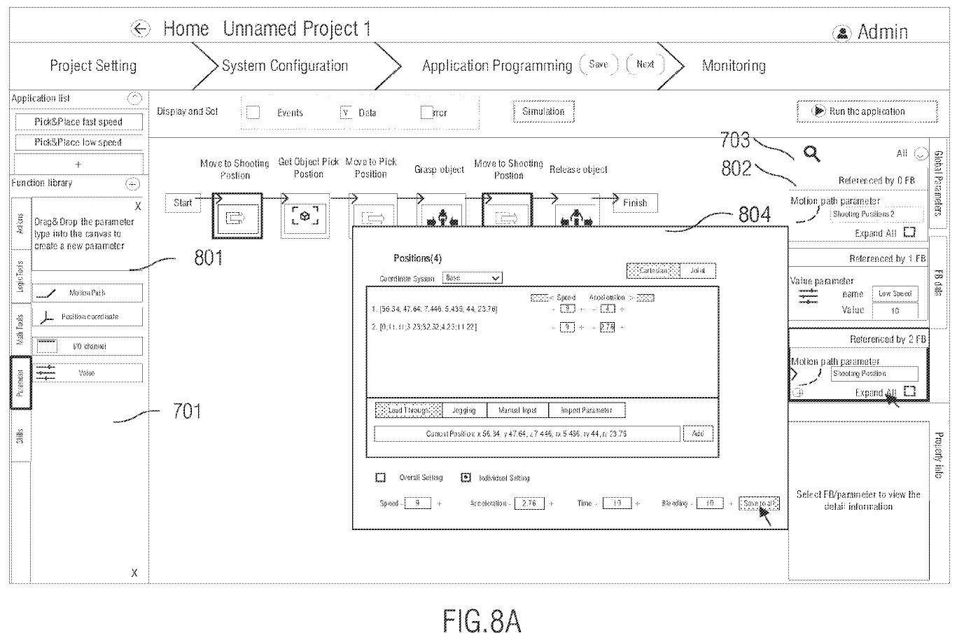

3) highlighting FBs using a global parameter (shown in FIG. 7);

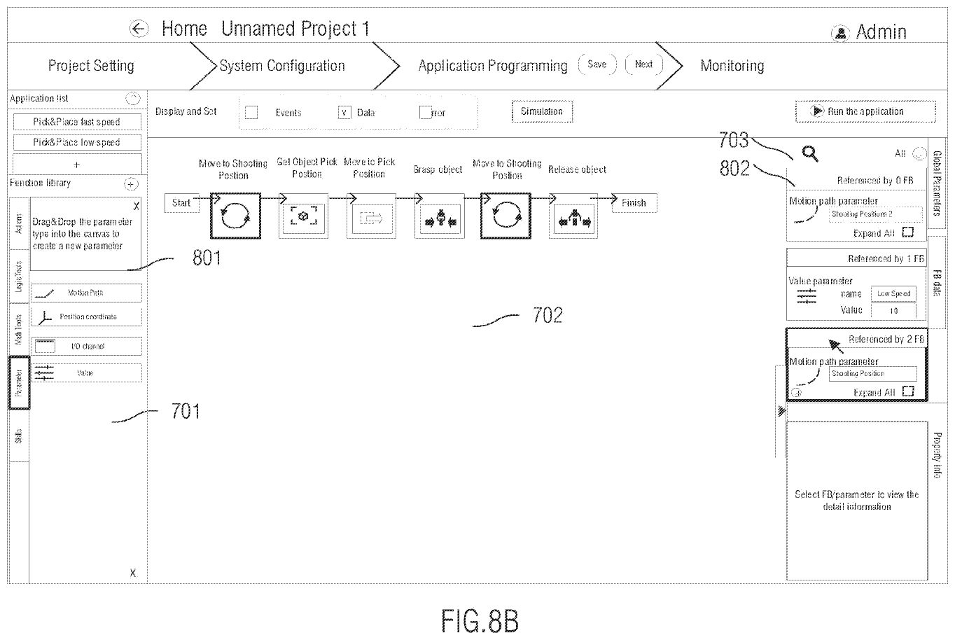

4) modifying a global parameter and expanding the modification to FBs (shown in FIG. 8A and FIG. 8B);

As shown in the upper figure in FIG. 5A, when a control of type “Motion path” is dragged from the function library 801 to the second user interface 702, a new control 803 will be shown on the second user interface 702 with an adding button “+” for the user to edit data items of the global parameter. When the user clicks on the adding button, a popup window 804 will be displayed, on which the global parameter can be edited. When the user finishes editing and clicks on the button “done”, the popup window 804 will be closed and the control 803 will display the editing result (“4 positions”). The user can click on the button “save” to save the editing to the global parameter. Then a new card 802 of created global parameter will be displayed in the list 802′ (shown in the bottom figure in FIG. 5A).

Now referring to FIG. 5B, procedure of creation of a global parameter of type “Position coordinate” will be described. In the step 1, when a control corresponding to type “Position coordinate” is dragged from the function library 801 to the second user interface 702, a new control 803 will be shown on the second user interface 702. The user can click on the upper control to rename the global parameter, and click on the lower control to set/modify values of data items of the global parameter. In the step 2, after clicking the value area, the user can set value by choosing “Leadthrough” (used in robotic teaching, the user leads through a robot, then motion path and points on the motion path can be learned by the robot), “Manual input” (the user will manually input values of the position coordinates) or “select parameter” (the user can choose to select from a parameter, such as a parameter in current application program or other application programs). After the user clicks on the button “save”, the parameter will be set as a global parameter and saved in the list 802′.

Now referring to FIG. 5C, the user can input name of a global parameter in the upper control and set the parameter by dragging the controller or input value directly. With the dragging-dropping-editing-listing steps, a global parameter of a desired type can be easily added and the adding result is also shown user-friendly and intuitively.

Now referring to FIG. 6A, the user can select a global parameter in the list 802′ and drag it to the second user interface 702. Then, FB(s) which can use the selected global parameter will be highlighted in a different way than other FBs. After setting relation of the global parameter with a specific FB (here, taking the FB “Move to Shooting Position” as an example, the global parameter can be moved as near as predefined to the specific FB, then the relation of the global parameter with the FB can be set). Once a global parameter is set relation with an FB, the FB will be displayed on the second user interface 702 in a hover status. s. After the user releases the card 802, a popup window 804 will be displayed automatically on the second user interface 702 and the global parameter will be edited (As shown in FIG. 6B). The highlighted “[Motion path] shooting position” is the correlated global parameter which is set relation with the FB. As shown in FIG. 6C, the parameter “[Motion path] shooting position” can be set as “local”, which means that here in the FB “Move to Shooting position”, the value of the parameter “[Motion path] shooting position” will be used, but any change of the local parameter here will not influence the former global parameter. While for the second parameter in the list, after the user clicks on the button 805, the parameter will be changed into a global one. Its name can be input by the user, and after the user clicks on the button “Save to Global Parameter”, the global parameter will be created and saved in the list 802′.

With the dragging-dropping-editing-listing steps, a global parameter can be easily referenced by one or multiple FBs. Use and editing of a global parameter in a FB can be much more easily and conveniently. As shown in FIG. 7, when a user hovers on a global parameter in the list 802′, on the second user interface 702, all FB(s) using the global parameter will be highlighted in a different way than other FB(s). Here, 2 functional blocks “Move to Shooting position” use the same global parameter “Shooting Positions”. Also, number of FB(s) using the global parameter is shown on top of the card 802 of the global parameter. FBs referring to a specific global parameter can be easily viewed.

Referring to FIG. 8A and FIG. 8B, a global parameter can be modified by clicking on the button “Expand All” and values of data items of the global parameter can be edited in the popup window 804. Once the user finishes editing and click on the button “Save to all”, the updates will be synchronized to all the FBs using the global parameter. As shown in FIG. 8B, the 2 highlighted FBs “Move to Shooting Position” have been synchronized.

A global parameter is different than local ones, modification on a global parameter will influence all FBs referring it. Here, with the easy operations “Expand All” and “Save to all”, a global parameter's modification can be easily expanded to each FB, saving programming time and results of synchronization be viewed intuitively.

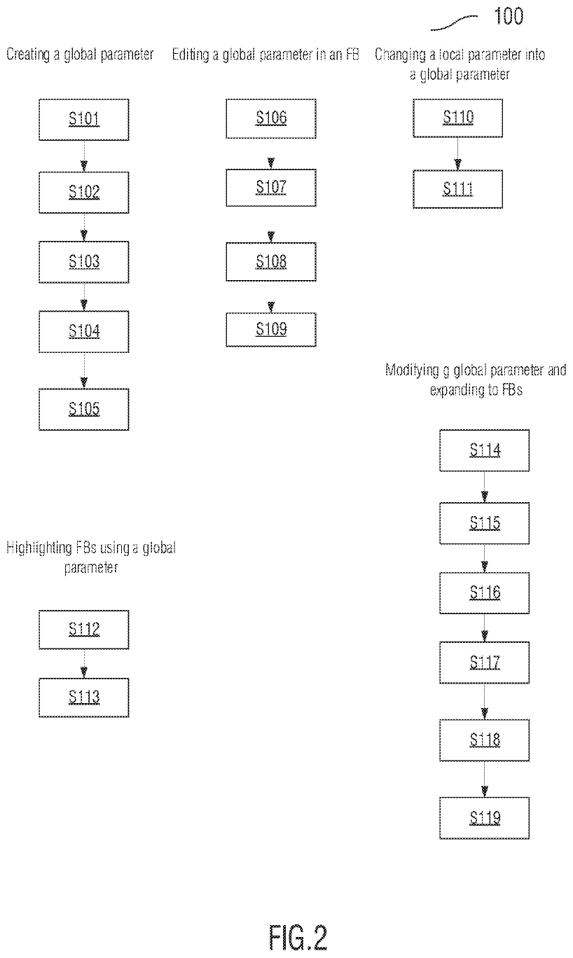

The user interaction module 201, the displaying module 202, and the processing module 203 are described above as software modules of the automatic programming program 20. In some embodiments, they can be implemented via hardware, such as ASIC chips. They can be integrated into one chip, or separately implemented and electrically connected. The architecture above is merely exemplary and used to explain the exemplary method 100 shown in FIG. 2.

One exemplary method 100 incorporating teachings of the present disclosure includes steps S101 to S118, which correspond respectively to above mentioned operations:

1) creating a global parameter

Following steps are included as to the operations of creating a global parameter:
S101: receiving a user's request on creating a first global parameter of a specific type by detecting the user's dragging a control corresponding to the specific type from a first user interface 701 and dropping the control on a second user interface 702;
S102: displaying a first popup window 804 for editing the first global parameter on the second user interface 702;
S103: receiving the user's editing operations on the first global parameter in the first popup window 804;
S104: creating the first global parameter according to the user's editing operations on the first global parameter;
S105: displaying a new added first card 802 of the first global parameter in a list 802′ of global parameters on a third user interface 703.

2) editing a global parameter in an FB

Following steps are included as to the operations of editing a global parameter:
S106: receiving the user's request of setting relation of a second global parameter with a first FB displayed on the second user interface 702 by detecting the user's dragging of a second card 802 of the second global parameter from the third user interface 703 and dropping on the second user interface 702 if predefined condition is met;
S107: displaying a second popup window 804 for editing the second global parameter on the second user interface 702;
S108: receiving the user's editing operations on the second global parameter in the second popup window 804;
S109: setting the first FB according to the user's operations on the second global parameter.

In some embodiments, for changing a global parameter into a local one, in the step S109, a first local parameter can be created and values of data items of the second global parameter inherited to the first local parameter.

In some embodiments, for changing a local parameter into a global one, further steps can be executed after the step S109:
S110: creating the third global parameter and inheriting values of data items of the second local parameter to the third global parameter; and
S111: displaying a new added third card 802 of the third global parameter in the list 802′ of global parameters on a third user interface 703.

3) highlighting FBs using a global parameter

Following steps are included as to the operations of creating a global parameter:
S112: detecting the user's selecting a fourth card 803 of a fourth global parameter;
S113: displaying at least one FB using the fourth global parameter in a highlighted way on the second user interface 702.

4) modifying a global parameter and expanding the modification to FBs

Following steps are included as to the operations of modifying a global parameter and expanding to FBs:
S114: receiving the user's modification request on a fifth global parameter by detecting the user's clicking on a first button on a card 802 of the fifth global parameter;
S115: displaying a third popup window 804 for editing the fifth global parameter on the second user interface 702;
S116: receiving the user's editing operations on the fifth global parameter in the third popup window 804;
S117: updating all FBs referring to the fifth global parameter when detecting the user's clicking on a second button in the third popup window 804;
S118: closing the third popup window 804; and
S119: displaying the updating status of all FBs referring to the fifth global parameter.

In some embodiments, a computer-readable medium stores computer-executable instructions, which upon execution by a computer, enables the computer to execute any of the methods presented in this disclosure. A computer program, which is being executed by at least one processor and performs any of the methods presented in this disclosure.

An automatic programming enhancement solution is provided in the present disclosure, which allows:

1) Using different parameter types to distinguish value reuse scenario. Each parameter type has a fixed structure and friendly interface to identify. UI elements can be distinguished with data input usage (e.g. “motion path”, “value”, etc.).

2) User can quickly save, reference and copy reusable global parameters and data output values. On one hand, frequently used parameters can be referenced by and copied to different FBs; on the other hand, global parameters can also be dragged and dropped for reference by FBs.

3) Global parameters can be visually identified and modified in referenced FBs. Global parameters' modification can be applied to all referring FBs. And global parameters and local parameters can also be distinguished during editing in FBs. For quickly getting a view of global parameter's usage in FBs, FBs related can be highlighted when a global parameter is selected.

While the present technique has been described in detail with reference to certain embodiments, it should be appreciated that the present technique is not limited to those precise embodiments. Rather, in view of the present disclosure which describes exemplary modes for practicing the teachings herein, many modifications and variations would present themselves, to those skilled in the art without departing from the scope and spirit of this disclosure. All changes, modifications, and variations coming within the meaning and range of equivalency of the claims are to be considered within their scope.

What is claimed is:

1. A method for automatic programming, the method comprising:
receiving a user's request to create a first global parameter of a specific type by detecting the user's dragging a control corresponding to the specific type from a first user interface and dropping the control on a second user interface;
displaying a first popup window for editing the first global parameter on the second user interface;
receiving the user's editing operations on the first global parameter in the first popup window;
creating the first global parameter according to the user's editing operations; and
displaying a new added first card of the first global parameter in a list of global parameters on a third user interface.

2. The method according to claim 1, further comprising:
receiving the user's request of setting relation of a second global parameter with a first function block displayed on the second user interface by detecting the user's dragging of a second card of the second global parameter from the third user interface and dropping on the second user interface if a predefined condition is met;
displaying a second popup window for editing the second global parameter on the second user interface;
receiving the user's editing operations on the second global parameter in the second popup window; and
setting the first function block according to the user's operations on the second global parameter.

3. The method according to claim 2, wherein:
the user's editing operations include changing the second global parameter into a local parameter; and
setting the first function block according to the user's operations on the second global parameter comprises: creating a first local parameter and inheriting values of data items of the second global parameter to the first local parameter.

4. The method according to claim 2, wherein the user's editing operations include changing a second local parameter into a third global parameter; and
the method further comprises:
creating the third global parameter and inheriting values of data items of the second local parameter to the third global parameter; and
displaying a new added third card of the third global parameter in the list of global parameters on a third user interface.

5. The method according to claim 1, further comprising:
detecting the user's selecting a fourth card of a fourth global parameter;
displaying at least one function block using the fourth global parameter in a highlighted way on the second user interface.

6. The method according to claim 1, further comprising:
receiving the user's modification request on a fifth global parameter by detecting the user's clicking on a first button on a card of the fifth global parameter;
displaying a third popup window for editing the fifth global parameter on the second user interface;
receiving the user's editing operations on the fifth global parameter in the third popup window;
updating all function block referring to the fifth global parameter when detecting the user's clicking on a second button in the third popup window;
closing the third popup window and displaying the updating status of all FBs referring to the fifth global parameter.

7. The method according to claim 1, wherein types of a global parameter comprise at least one of the following items:
a motion path including at least one position group, each position group corresponds to a point on a motion path, data items of each position group include position coordinates, speed and acceleration;
a position coordinate;
an I/O channel; and
a value.

8. An apparatus for automatic programming, the apparatus comprising:
a user interaction module configured to receive a user's request on creating a first global parameter of a specific type by detecting the user's dragging a control corresponding to the specific type from a first user interface and dropping the control on a second user interface;
a displaying module configured to display a first popup window for editing the first global parameter on the second user interface; and
a processing module configured to receive the user's editing operations on the first global parameter in the first popup window and create the first global parameter according to the user's editing operations;
wherein the displaying module is further configured to display a new added first card of the first global parameter in a list of global parameters on a third user interface.

9. The apparatus according to claim 8, wherein
the user interaction module is further configured to receive the user's request of setting relation of a second global parameter with a first function block displayed on the second user interface by detecting the user's dragging of a second card of the second global parameter from the third user interface and dropping on the second user interface if a predefined condition is met;
the displaying module is further configured to display a second popup window for editing the second global parameter on the second user interface;
the user interaction module is further configured to receive the user's editing operations in the second popup window; and
the processing module further configured to set the first function block according to the user's operations.

10. The apparatus according to claim 9, wherein:
the user's editing operations include changing the second global parameter into a local parameter; and
the processing module is further configured to create a first local parameter and inheriting values of data items of the second global parameter to the first local parameter, when setting the first function block according to the user's operations on the second global parameter.

11. The apparatus according to claim 9, wherein:
the user's editing operations include changing a second local parameter into a third global parameter;
the processing module is further configured to create the third global parameter and inherit values of data items of the second local parameter to the third global parameter; and
the displaying module is further configured to display a new added third card of the third global parameter in the list of global parameters on a third user interface.

12. The apparatus according to claim 8, wherein:
the user interaction module is further configured to detect the user's selecting a fourth card of a fourth global parameter; and
the displaying module is further configured to display at least one functional block using the fourth global parameter in a highlighted way on the second user interface.

13. The apparatus according to claim 8, wherein
the user interaction module is further configured to receive the user's modification request on a fifth global parameter by detecting the user's clicking on a first button on a card of the fifth global parameter;
the displaying module is further configured to display a third popup window for editing the fifth global parameter on the second user interface;
the user interaction module is further configured to receive the user's editing operations on the fifth global parameter in the third popup window;
the processing module is further configured to update all function blocks referring to the fifth global parameter when detecting the user's clicking on a second button in the third popup window; and
the user interaction module is further configured to close the third popup window and display the updating status of all FBs referring to the fifth global parameter.

14. The apparatus according to claim 8, wherein types of a global parameter comprise at least one of the following items:
a motion path including at least one position group, each position group corresponding to a point on a motion path, data items of each position group include position coordinates, speed and acceleration;
a position coordinate;
an I/O channel; and
a value.

15. An apparatus for automatic programming, the apparatus comprising:
a processor; and
a memory coupled to the processor and storing a set of instructions;
wherein the set of instructions, when executed by the processor, causes the processor to:
receive a user's request to create a first global parameter of a specific type by detecting the user's dragging a control corresponding to the specific type from a first user interface and dropping the control on a second user interface;
display a first popup window for editing the first global parameter on the second user interface;
receive the user's editing operations on the first global parameter in the first popup window;
create the first global parameter according to the user's editing operations; and
display a new added first card of the first global parameter in a list of global parameters on a third user interface.

16. (canceled)
